(19) United States
(12) Patent Application Publication
(10) Pub. No.: US 2025/0078675 A1
(43) Pub. Date: Mar. 6, 2025

(54) SOCIAL INTERACTION TRAINING APPARATUS AND METHOD

(71) Applicant: SOCIAL OPTICS INC., Bozeman, MT (US)

(72) Inventor: Carolyn Long, Bozeman, MT (US)

(21) Appl. No.: 18/827,087

(22) Filed: Sep. 6, 2024

Related U.S. Application Data
(60) Provisional application No. 63/536,815, filed on Sep. 6, 2023.

(51) Int. Cl. G09B 5/02

(52) U.S. Cl. CPC G09B 5/02

(57) ABSTRACT

One aspect of the present disclosure provides systems and methods for determining student progress across a multivariate set of learning goals and personalizing teaching content across a multivariate set of learning goals using a learning management system, including providing first teaching content to a client-side electronic device, in which the client-side electronic device is associated with a user account, receiving one or more user inputs via the client-side electronic device, processing the one or more user inputs through a machine learning model, the machine learning model trained to determine performance data for a plurality of skills categories based on the one or more user inputs, and determining, for the user account, performance data for the plurality of skills categories based on the one or more user inputs.

### CROSS-REFERENCE TO RELATED APPLICATIONS

The present application claims priority to provisional patent application 63/536,815 entitled “SOCIAL INTERACTION TRAINING APPARATUS AND METHOD”, filed on Sep. 6, 2023, the entire disclosure of which is incorporated by reference herein.

### FIELD OF THE DISCLOSURE

The present disclosure relates generally to apparatuses and methods for development of emotional and social cognitive skills for neurodivergent students and gathering of human emotional and social cognitive data toward building machine learning models of human social interaction.

### BACKGROUND

Neurodivergent students as a general matter have difficulty in recognizing and interpreting non-verbal emotional cues and other environmental information that provide context for human social interaction and communication, and that define what may be considered appropriate reactions or behavior in a given social situation. Neurodivergent students include those on an autism spectrum that exhibit these characteristic communication and emotional difficulties. Studies have been performed for improving the skillsets of neurodivergent individuals to enable them to have more fulfilled lives and function as well as possible in social situations and life generally.

Research has been performed for decades in adolescent language, social pragmatics, gifted and talented education (Kaplan's Depth and Complexity model), identity theory, and social emotional development. Supporting students with opportunities to learn and engage with peers with similar abilities, interests, and motivation as well as providing social-emotional curriculum designed for students with unique learning abilities is crucial to success in school and beyond (Neihart et al.,2002; Reis and Renzulli, 2004). Self-determination plays a huge role in the success of all students, but it is critical in the education of neurodivergent students who may have an unclear picture of their own autonomy. Self-determination has been defined as an individual having opportunities and supports to make or cause things to happen in their life. Research over the past twenty-five years has shown that self-determined young people have more positive employment, postsecondary education, and community participation outcomes. Self-determined people set and go after goals that are important to them and use an understanding of their strengths and support needs and the resources available to them in their communities″ (Shogren et al., 2021).

### BRIEF DESCRIPTION OF THE DRAWINGS

FIG. 1 is a block diagram of a social interaction training apparatus for neurodivergent students in accordance with various embodiments.

FIG. 2 is block diagram of a cloud application for a social interaction training apparatus in accordance with some embodiments.

FIG. 3 is an example graphical user interface (GUI) illustrating a student dashboard of an intelligent learning management system in accordance with an embodiment.

FIG. 4 is an example graphical user interface (GUI) screen illustrating the lenses module main page of a cloud application in accordance with an embodiment.

FIG. 5 is an example graphical user interface (GUI) screen showing a student homepage of a cloud application in accordance with an embodiment.

FIG. 6A and FIG. 6B are examples of social scenarios provided by the cloud application where the social scenarios are provided.

FIG. 7 is an example character showing their appearance and color scheme specifications for the cloud application GUI in accordance with an embodiment.

FIG. 8 is an example character showing their appearance, color scheme, and personality specifications for the cloud application GUI in accordance with an embodiment.

FIG. 9 is an example of a graphic novel generated by the cloud application prompting the student for natural language inputs.

FIG. 10 is a block diagram of a machine learning model for a social interaction training apparatus in accordance with various embodiments.

FIG. 11 is a flow chart showing operation of a cloud server processor in accordance with various embodiments.

FIG. 12 is a flow chart showing operation of a cloud server processor in accordance with an embodiment.

FIG. 13 is a flow chart showing operation of a cloud server processor in accordance with an embodiment.

FIG. 14 is a flow chart showing operation of a cloud computer system in accordance with an embodiment.

FIG. 15 is a flow chart showing operation of a cloud computer system in accordance with an embodiment.

FIG. 16 is a flow chart showing operation of a cloud computer system generating machine learning training data in accordance with an embodiment.

FIG. 17 is a flow chart showing operation of a cloud computer system in accordance with an embodiment.

FIG. 18 is a flowchart depicting a method for determining student progress across a multivariate set of learning goals, in accordance with an embodiment of the present disclosure.

FIG. 19 is a flowchart depicting a method for personalizing teaching content across a multivariate set of learning goals, in accordance with an embodiment of the present disclosure.

### DETAILED DESCRIPTION

This patent document contains copyrightable computer software elements including screen displays and other copyrightable subject matter. The following notice shall apply to these elements: Copyright@ 2023 SOCIAL OPTICS INC., All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever, national and international.

Briefly, the present disclosure provides a social interaction training apparatus and method for neurodivergent students. The present disclosure provides a specialized computing apparatus with a specialized cloud application operative to provide individualized social interaction training and to provide feedback to teachers to enable monitoring and guidance of the students. Among other advantages, the presently disclosed apparatus and method provide improvements to the lives of neurodivergent students by providing them a mechanism to improve their social interaction cognitive skills in an enjoyable and individualized manner. While various aspects are described in the context of providing social interaction training to neurodivergent students, embodiments of the present disclosure are not limited thereto and may be used by any persons.

Among other things, the present disclosure provides a cloud application that is built on the understanding that humans seek connection and relationships as part of an innate biological drive that enriches our lives and helps us survive. The cloud application provides a curriculum designed around a student's core of identity, and weaves language, executive function, critical thinking, and self-awareness skills together to support a student's exploration of self. Through usage of the cloud application, students build language and communication skills that are critically important for adolescents and that directly impact their ability to create an identity, form and keep healthy relationships, have academic success, and find and sustain employment. Among other advantages, the cloud application provides students who utilize it with increased confidence and self-esteem and improved ability to identify and build healthy relationships. While various aspects are described using a cloud application (e.g., an application provided via a computer server, such as a web server), embodiments of the present disclosure are not limited thereto and may also be implemented in part or in whole using software installed locally on a client-side electronic device, such as a smartphone, a tablet computer, a laptop computer, or a desktop computer.

Additionally, the present disclosure provides apparatuses and methods for building machine learning models of human interaction. These machine learning models may be used to enhance and customize the training experience for students using the system however, these models also have applicability to training other artificial intelligence engines that are intended for interaction with humans such as, in one example, customer service systems and other systems, etc.

One aspect of the present disclosure provides an apparatus that includes: a cloud server, having non-volatile, non-transitory computer-readable memory; and at least one processor, operatively coupled to the non-volatile, non-transitory computer-readable memory. The at least one processor operative to: provide a graphical user interface comprising a plurality of selectable socio-cognitive cue categories, each of the selectable socio-cue cognitive categories correlated to interpretation of a social situation; receive selection input from a student user via the graphical user interface for at least one socio-cognitive cue category; provide a training module to the student user tailored to the selected at least one socio-cognitive cue categories in response to the selection input; and generate at least a portion of a graphic novel related to student user interaction with the training module.

In some embodiments, the at least one processor is further operative to provide the training module to the student user in an anime style format. In some embodiments, the at least one processor is further operative to generate at least a portion of a graphic novel in a manga style format. In some embodiments, the at least one processor is further operative to convert the graphic novel into a non-fungible token (NFT). In some embodiments, the at least one processor is further operative to provide a series of questions in the training module corresponding to the selected socio-cognitive cue category. In some embodiments, the at least one processor is further operative to generate a series of questions in the training module corresponding to the selected socio-cognitive cue category via an artificial intelligence engine trained using machine learning.

Another aspect of the present disclosure provides a method that includes: providing a graphical user interface comprising a plurality of selectable socio-cognitive cue categories, each of the selectable socio-cue cognitive categories correlated to interpretation of a social situation; receiving selection input from a student user via the graphical user interface for at least one socio-cognitive cue category; providing a training module to the student user tailored to the selected at least one socio-cognitive cue categories in response to the selection input; and generating at least a portion of a graphic novel related to student user interaction with the training module.

In some embodiments, the method may further include providing the training module to the student user in an anime style format. In some embodiments, the method may further include generating at least a portion of a graphic novel in a manga style format. In some embodiments, the method may further include converting the graphic novel into a non-fungible token (NFT). In some embodiments, the method may further include providing a series of questions in the training module corresponding to the selected socio-cognitive cue category. In some embodiments, the method may further include generating a series of questions in the training module, corresponding to the selected socio-cognitive cue category, generated by an artificial intelligence engine trained using machine learning.

Another aspect of the present disclosure is a cloud server computer system that includes executable instructions for execution by the cloud server computer system, that when executed cause the cloud server computer system to be operative to: provide an instance of a cloud application to an access device via a web browser executed on the access device and provide a graphical user interface (GUI) for display on the access device; receive user input from the GUI comprising answers to multiple choice questions and free form text in response to open ended questions related to socio-cognitive scenarios; generate a plurality of socio-cognitive profiles related to a user based on the user input; generate a machine learning model of human socio-cognitive interaction based on the socio-cognitive profiles; and apply the machine learning model to an artificial intelligence engine operatively coupled to the cloud application to enhance interaction between the cloud application and the user.

In some embodiments, the cloud server computer system is further operative to generate a series of multiple-choice questions and open-ended questions related to socio-cognitive scenarios via an artificial intelligence engine trained using machine learning. In some embodiments, the artificial intelligence engine is trained to generate multiple choice questions and open-ended questions using machine learning and the user input.

Another aspect of the present disclosure provides a cloud server computer system that includes executable instructions for execution by the cloud server computer system, that when executed cause the cloud server computer system to be operative to: communicate with a plurality of access devices via a cloud application, each access device provided an instance of the cloud application, to obtain socio-cognitive data related to a plurality of human subjects; provide the socio-cognitive data to a plurality of socio-cognitive category machine learning models, the socio-cognitive data used as training data; and apply the machine learning models to an artificial intelligence engine operatively coupled to the cloud application in a feedback mechanism to enhance interaction between the cloud application and human subjects via a graphical user interface.

In some embodiments, the cloud server computer system is further operative to provide the machine learning models to an artificial intelligence engine operatively coupled to a robotic system. In some embodiments, the cloud server computer system is further operative to obtain the socio-cognitive data related to a plurality of human subjects by providing a series of multiple-choice questions and open-ended questions to the human subject via a user interface of the cloud application. In some embodiments, the cloud server computer system is further operative to obtain the socio-cognitive data related to a plurality of human subjects by providing a series of questions corresponding to a social narrative provided to the human subjects. In some embodiments, the cloud server computer system is further operative to provide a social narrative to the human subjects in a manga style format.

In some embodiments, the cloud server computer system is further operative to provide a social narrative to the human subjects using anime-influence characters.

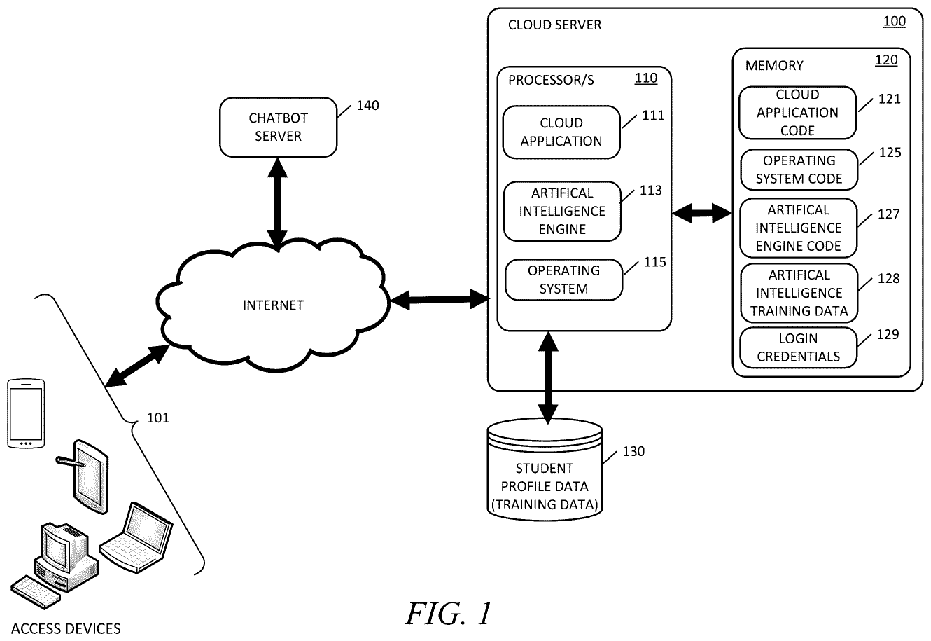

Turning now to the drawings wherein like numerals represent like components, FIG. 1 is a block diagram of a social interaction training apparatus for neurodivergent students in accordance with various embodiments. In FIG. 1, a cloud computer system includes at least one cloud server 100, with each cloud-server including at least one processor 110, and operatively coupled non-volatile, non-transitory memory 120 that stores executable instructions (code) that when executed by the processor, or processors, provides a multi-tenant cloud application environment, a single-tenant cloud application environment or a combination of both. The executable instructions, when executed by the processor, or processors, enable the multi-tenant cloud application environment to provide multiple application instances to various computer systems serving as access devices 101 (such as, but not limited to, smartphones, tablets, laptop computers, desktop computers, etc.). Likewise, the executable instructions, when executed by the processor, or processor, enable a single-tenant cloud-based application environment to provide multiple application instances to a single access device. The cloud infrastructure enables interoperability and data exchange and sharing between various access devices 101 that may be operated by students and teachers.

The non-volatile, non-transitory memory 120 stores executable instructions including cloud application code 121 that when executed by operatively coupled processor/s 110 renders the processor/s 110 operative to provide cloud application 111. Operating system code 125, when executed by the processor/s 110 provides operating system 115. Artificial intelligence engine code 127, when executed by processor/s 110 renders the processor/s 110 operative to provide artificial intelligence engine 113. The non-volatile, non-transitory memory 120 also stores artificial intelligence (AI) training data 128 and login credentials 129. The login credential 129 include account and login information for all access device 101 users (students and teachers) that access the cloud application 111. The cloud application 111 is operative to provide an instance of the cloud application 111 to each logged in access device, via a TCP/IP connection that may include one or more WebSocket connections. Each access device 101 is provided with a graphical user interface (GUI) to the cloud application 111 via, for example, a web browser executing on the access device. The GUI is representative of an instance of the cloud application 111 provided to an access device user.

As students login and interact with the cloud application 111, student profile data is built and stored in student profile database 130. The processor/s 110 is operatively coupled to the student profile database 130 and is operative to store data and retrieve data therefrom.

The cloud application 111 is operatively coupled via one or more application programming interfaces (APIs) to the AI engine 113. The cloud application 111 is also operative to communicate with a chatbot server 140 via at least one API over the internet.

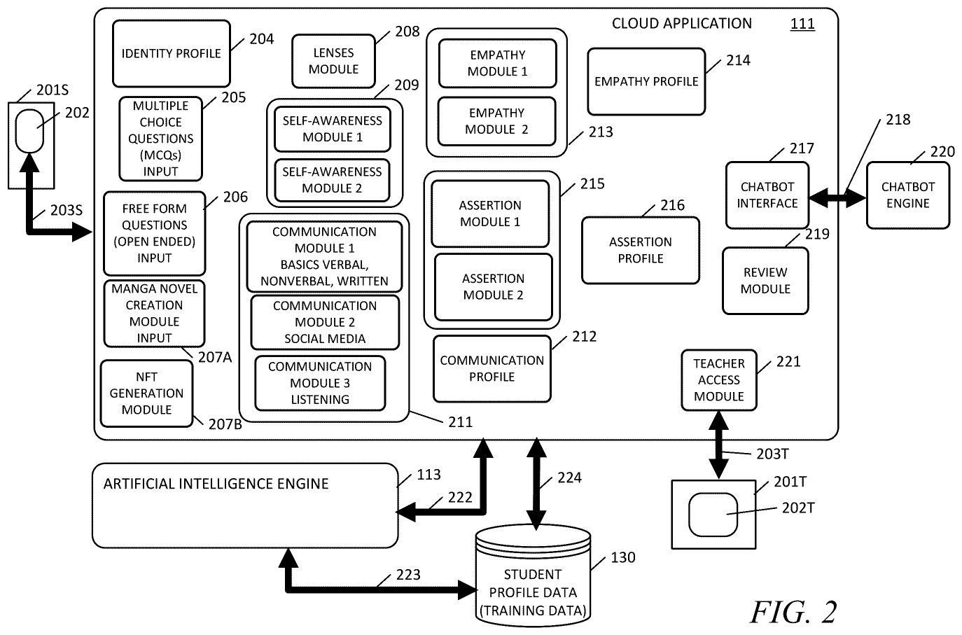

FIG. 2 is block diagram providing example details of the cloud application 111 for a social interaction training apparatus in accordance with some embodiments. The cloud application 111 as executed by the processor/s 110 renders the processor/s 110 operative to establish a TCP/IP connection 203S, which may include one or more WebSocket connections, to provide an instance of the cloud application 111 via a GUI 202 within a browser executing on a student access device 201S. Similarly, a teacher may use an access device 201T and a browser to obtain an instance of a teacher instance of the cloud application 111 via GUI 202T and TCP/IP connection 203T. A teacher access module 221 provides a teacher interface to the cloud application 111.

The cloud application 111 includes a multiple-choice question (MCQ) input module and a free form question module 206 than enables text input answers in free form text for open ended questions. A manga novel creation module 207A is also operative to receive free form text input. All of the inputs are received via inputs entered into the GUI 202 on the student access device 201S. A non-fungible token (NFT) generation module 207B is operative to convert the manga style format graphic novel into one or more NFTs. For example, on NFT may be related to student created content, while other NFTs may be related to the underlying manga style format content generated by the AI engine 113 or by the cloud application 111.

The cloud application 111 also includes a lenses module 208, self-awareness modules 209, communication modules 211, empathy modules, assertion modules 215 and review module 219. Each of the modules includes online lessons that are designed based on research in direct instruction, special education curriculum design, and gifted and talented pedagogy. The lessons use spaced retrieval to improve concept retention and provide opportunities for application and generalization.

The term “lenses” as used herein refers to socio-cognitive cue categories that may be applied by neurodivergent students to analyze and understand various communications and human interaction situations. The lenses module 208 includes online lessons that correlate to each of the critical thinking lenses that are used throughout the course. Students learn about each lens with practical examples and application opportunities.

The self-awareness modules 209 include two modules in a sequence. The two modules provide students objective information about self-concept and identity. They explore the relationship between internal and external factors that impact how students feel and think about themselves. Students gain an understanding of these dynamics and how they have control and tools for shaping them. Students also create their own identity profile 204 in each module using the lenses of lenses module 208.

The communication modules 211 include three modules in a sequence. The first module focuses on the basics of communication including nonverbal and verbal language, and written forms. The second communications module focuses on social media and third communications module focuses on listening. The sequencing of the communication modules allows students to use the lenses to break down the complex rules of verbal and nonverbal communication, social media, and the art of listening to others.

The students learn how to take observable information and pair it with prior knowledge to adapt to the nuanced rule changes that take place in different situations. They create their own communication profile 212 describing how they see themselves as social communicators.

The two empathy modules 213 teach students several different perspectives on empathy grounded in a common definition. Students get to explore what empathy looks like for others and for them. They create an empathy profile 214 that helps them understand how, when, and where they show empathy for others, and its importance in developing and maintaining healthy relationships.

The two assertion modules 215 present a common definition of assertion, and also compare and contrast the shared characteristics with self-advocacy. Students use the lenses of lenses module 208 to uncover how assertion and self-advocacy are viewed in different contexts, learn research-based strategies, tips and tricks for improving these skills, and develop their own assertion profile 216 including goals.

The review module 219 is the final module for the course, and students will review the big ideas taught about the lenses, self-awareness, communication, empathy, and assertion. They will use the review of this knowledge and put everything together into a big picture. This allows them to gain a better understanding of their own self, how they communicate, what areas they would like to improve, and who they are.

The identity profile 204, communication profile 212, empathy profile 214 and assertion profile 216 are stored for each student in the student profile database 130 via database API 224. The AI engine 113 is operative to access the various profiles contained in the student profile database 130 and uses this data to customize the cloud application 111 lesson structure for each student. The student profiles may also be used as training data for training the AI engine 113.

The AI engine may be, in some example embodiments, a large language model (LLM) engine. The AI engine 113 operations are based on machine learning and data collection and analysis by machine learning algorithms performed over a period of time. The AI engine 113 is operative to receive input data via the MCQ input module 205, the free form question input module 206 and from the various student profiles, and evaluate whether some input data, profiles or both, are related to other input data received during a given time interval and from the various modules.

For example, if as a student enters information via the multiple-choice input module 205 the AI engine 113 may create an identity profile for use in comparison with the student created identity profile 204 and to adjust the model if needed. Likewise, the AI engine 113 is operative to monitor all the other profiles; such as communication profile 212, empathy profile 214, and assertion profile 216, as well as the free form question input module 206.

In some embodiments, additional questions for the specific student are generated by the AI engine 113. Additionally, various social-cognitive scenarios may be generated and simulated by a machine learning algorithm that has been fed appropriate amounts of data from the various inputs and profiles from various students to form a training procedure that is used to train the model of the AI engine 113. In other words, in some embodiments the AI engine 113 is trained by machine learning algorithms subsequent to the machine learning algorithms evaluating appropriate amounts of student data for individualized lessons. The individualized lessons in some embodiments may involve, among other actions, comparing progressive student inputs into the various lessons by the machine learning algorithm with the student inputs from an overall previous training data and adjusting the algorithm or model accordingly. Thus, in some embodiments, the AI engine 113 may be a rule-based logic system that applies predetermined rules stored either within the memory 120 as AI training data 128, or within the operatively coupled external memory of student profile database 130. While in other embodiments, the AI engine 113 is trained via machine learning algorithms. In some embodiments, the AI engine 113 includes a large language model (LLM) that is configured by a prompt (e.g., a system prompt), where the prompt includes examples taken from the AI training data 128.

In some embodiments, the cloud application may include a chatbot interface 217 operative to communicate with a chatbot engine 220 via an API 218. The chatbot engine 220 may be, for example, a large language model-based chatbot such as, but not limited to, ChatGPT, Llama, Phi, or some other like chatbot that is operative to respond to questions and compose various written content, including questions and generate socio-cognitive scenarios. In some embodiments, the chatbot interface 217 works in conjunction with the teacher access module 221 to format student reports based on student data collected by the cloud application 111, the AI engine 113 or both.

In operation of the cloud application 111, a student is presented with set of social settings and scenarios that involve a social interaction narrative requiring the student to apply socio-cognitive cue categories (referred to herein as “lenses”) to analyze and understand contextually the proper responses, emotions or behaviors that would be appropriated for the given social interaction narrative. In some embodiments, scenarios are presented using characters in graphic novel format with anime-influenced character appearance and anime-influenced animation in some embodiments. The term “anime-influenced” as used herein refers to cartoon work and comics work, whether hand-drawn or computer-generated, with an appearance similar to “anime” as originated in Japan, however, the present works are anime-influenced in that they do not originate in Japan. The works described herein are also in a manga style format. The term “manga style format” refers to comics or graphic novels with an appearance and format similar to manga which are comics or graphic novels originating in Japan. However, the manga style format comics and graphic novels described herein do not originate in Japan. While various aspects are described herein in the context of manga style or anime-influenced designs, embodiments of the present disclosure are not limited thereto, and the scenarios may be presented using various other artistic styles.

The cloud application 111 interacts with students via technology aided instructions (with intervention by teacher capability to use software-assessment and instruction), direct instructions via online lessons and supplemental lessons, social narrative in lessons and via creation of a manga style format novel, video modeling, modeling, social skills training, task analysis (via the lenses as defined herein, and using visual supports such as the lenses and manga novel and scripting such as the student created manga style format novel. The cloud application 111 uses a flipped classroom approach and teach-back opportunity such as via the graphic novel and uses gamification to increase student engagement and participation by way of the anime-influence characters and manga style format which provides a game-like interface.

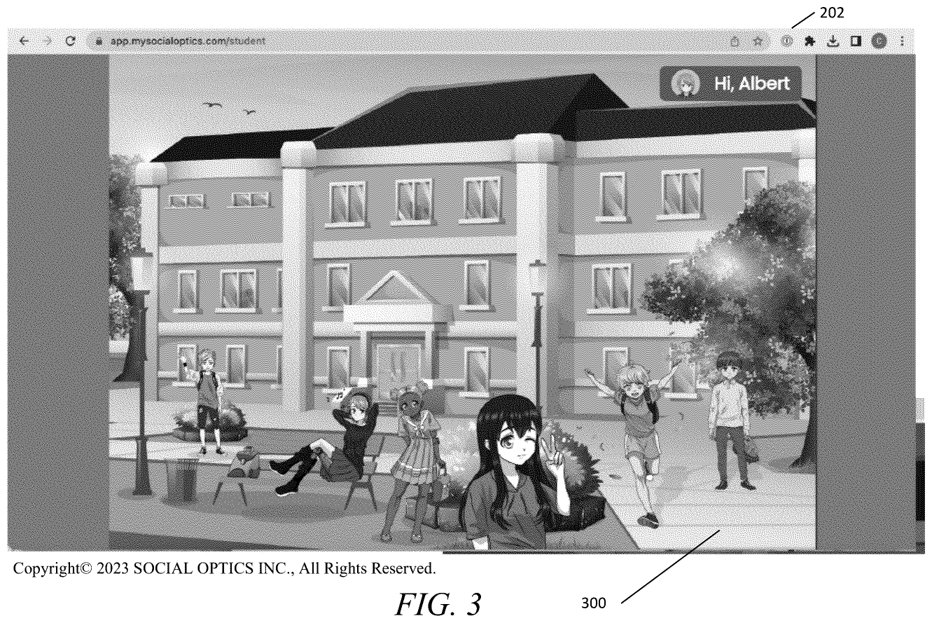

FIG. 3 is an example of the graphical user interface (GUI) 202 screen showing a student homepage or dashboard of the cloud application 111 in accordance with an embodiment. The dashboard is in a manga style format and shows anime-influenced characters. From the dashboard, a student is able to access the various lesson modules. The dashboard may be navigated via a list menu and making selections via a mouse cursor click on a desired list menu item, or by selection of icons or anime-influenced objects. Lessons may be in a variety of formats including a slide-based format with audio, an animated video format with audio, etc.

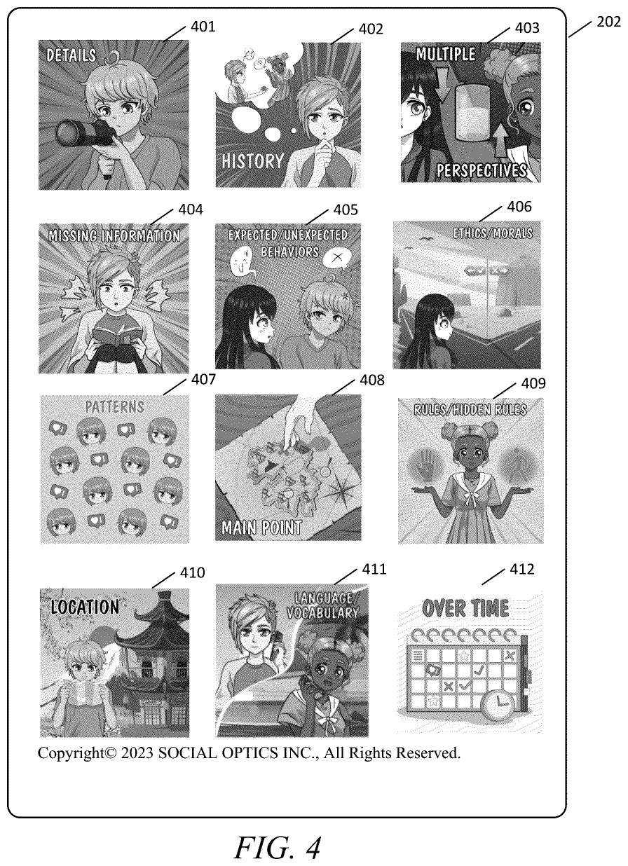

FIG. 4 is an example of the GUI 202 screen showing a screenshot of the lenses module 208 main page of the cloud application 111 in accordance with an embodiment. Each “lens” refers to a socio-cognitive cue/skill category and is presented as an icon in manga style format and in some icons shows one or more anime-influence characters. The lenses include details 401, history 402, multiple perspectives 403, missing information 404, expected/unexpected behaviors 405, ethics/morals 406, patterns 407, main point 408, rules/hidden rules 409, location 410, language/vocabulary 411 and over time 412.

The details 401 lens refers to the socio-cognitive concept of viewing details as a part of a whole, and to report minutely and distinctly; to report with close attention to small elements observable, quantifiable data—information you can see, touch, taste, smell, and hear. Student attention is drawn to objects, and to how many details they can observe through their five senses. For example, the student may be shown pictures and asked questions such as how many details they can observe, which of their five senses plays the biggest role, and which of their five senses they do not use. In another example, students may be presented with social situations and asked how many details they can observe with each of their five senses, and for which sense they have the most/least number of observations. Because social interpretation and social problem-solving skills will only ever be as good as the student's ability to identify details, the more details they have to use in creating the social picture, the more likely they are to produce more accurate interpretations of social situations.

The history 402 lens refers to the socio-cognitive concepts of a chronological record of significant events; an established record; events of the past; and previous treatment or experience. Students are asked to consider what they already know about a given social situation, what they know about the people, what they know about past outcomes, and what they know about how people felt or acted. The students are asked if they can relate a given social situation to other situations that they have either experienced, role-played in a class, seen in a movie, or heard about in conversations with friends. When people interact with others they are always building and using information from ‘friend files’ or prior knowledge to make split second decisions on what to say or do in order to achieve their communication goal. The more the students learn to use and rely on previous knowledge, or ‘history,’ the better they become at making ‘smart guesses’ about expected and unexpected social responses.

The multiple perspectives 403 lens refers to the socio-cognitive concepts of multiple-shared by many; more than one perspective-a mental view or prospect; a visible scene; and the capacity to view things in their true relations or relative importance. Because we all view situations differently based on our own experiences, the trick is to get better at making ‘smart guesses’ about someone else's experiences in order to figure out what they may be thinking in any given situation. The students are asked what other lenses shape a person's perspective in a given social interaction or social situation, and how knowledge of a person's history, patterns, and ethics/morals affect their perspective. The students are asked how they use details during a social situation to predict a person's perspective, and how being able to make a ‘smart guess’ about other possible perspectives may help during a social situation/interaction.

The missing information 404 lens refers to the socio-cognitive concepts of missing—absent; lost Information-knowledge obtained from investigation, and study or instruction. In any given social interaction, there are 3 parts: 1) what we know, 2) what the other person knows, and 3) missing information. The students are asked how they can use details to identify what they know in a social situation, how they can use details to identify what someone else knows in a social situation, and what are some types of missing information that they may not know but would be important for making smart guesses about how to act/interact in a social situation. For example: if the person had something bad happen earlier that day that is impacting their mood; if they've experienced this situation before and had their feelings hurt; if they know a teacher already told other students not to do it, etc.

The expected/unexpected behaviors lens 405 refers to the socio-cognitive concepts of expected—to look forward; to consider reasonable, due or necessary; unexpected—not expected; unforeseen; unanticipated Behaviors—the way or manner in which someone conducts oneself. There are certain behaviors that we look forward to, or expect people to demonstrate in many, many settings. For example, we expect people to take items from their cart then face forward and keep their bodies quiet while checking out in a grocery store. Sometimes, we expect that people may make small talk if the lines are really long or people have to wait and they are by themselves. If someone is waiting in line with their kids or a friend, we expect them to talk with them and not us. Students are asked how do we know what to expect, how can we use details and history to identify what is expected in a social situation, how can they use details to identify when we or someone else did something that was unexpected, how do we feel when we can predict expected behaviors, and how do we feel when someone acts unpredictably—their behaviors are unexpected for the situation.

The ethics/morals lens 406 refers to the socio-cognitive concepts of ethics—the discipline dealing with what is good and bad and with moral duty and obligation; the principles of conduct governing an individual or group; morals—of or relating to principles of right and wrong in behavior; and conforming to a standard of right behavior. Moral development is the process through which children develop proper attitudes and behaviors toward other people in society, based on social and cultural norms, rules, and laws. Morality develops across a lifetime and is influenced by an individual's experiences. Ethics/morals are, very often, the guiding force behind how we interpret and respond to social information and situations. The students investigate the questions of what are some societal morals that we follow (for example: don't cheat, lie or steal, do not hurt or kill anyone, etc.), what are some cultural morals that we follow (for example: ‘southern hospitality,’ ‘individuals who live in rural areas helping fellow neighbors,’ ethnic neighborhoods in larger cities, etc.), and are asked to give an example of a personal moral or value that is important to them, and how this could affect how they might communicate with someone.

The patterns 410 lens refers to the socio-cognitive concepts of patterns—a reliable sample of traits, acts, tendencies, or other observable characteristics of a person, group or institution; a form or model proposed for imitation. Patterns are everywhere. We can see patterns in nature, art, grocery stores, with our teachers, friends and family—you name it and if you study the “details” (as in the details lens module) long enough, over time (as in the over time lens module), you will see patterns unfold. Students are asked how patterns help us, and shows that patterns help us to predict what comes next in an activity or how people may react. They allow us to plan our social interactions or responses in order to achieve our desired outcome. Students are asked to give an example of a pattern of behavior that they see in their parents, a teacher or a friend, and how they can use the details lens and the over time lens to identify patterns of behavior in others. The students are asked that if they know that their action will likely cause an unpredictable response in another person, how is actually knowing that they don't know what the other person will say or do another form of prediction.

The main point 408 lens refers to the socio-cognitive concepts of main point (gestalt)-the general quality or character of something; something that is made of many parts and yet is somehow more than or different from the combination of its parts. The students investigate how they can find the ‘big reason’ or ‘why’ behind a conversation or when they're reading a story. Being able to find lots of “details” helps build a picture or “pattern” that helps identify the “main point” of a conversation, story or social interaction. Students are taught that it is important to not get stuck on a detail but rather to examine many details. Such that, when students know why someone is talking to them, they can make better ‘smart guesses’ about what to say or do next. Students are asked to think of a time when they got stuck on details and missed the main point of a message, and what happened as a result. The students are asked if they have ever had a friend insist they were mad or angry at them because they started a conversation with how they were feeling but ended it with why they were no longer upset—but all their friend heard was the first part of what they said and their friend missed the ‘main point’—that everything is okay now. The students are asked how they know when they've successfully identified the “main point” of a conversation, movie, book or topic.

The rules/hidden rules 409 lens refers to the socio-cognitive concepts of: rules—a prescribed guide for action or conduct; an accepted procedure, custom or habit; a standard of judgment; a regulating principle; and hidden rules—accepted customs, procedures or habits that are not formally stated aloud or written down. The term “hidden rules” is used to explain that there are social expectations that teachers, parents, and peers don't talk about, but that we are all expected to follow based on what's happening around us (the situation/context). And, since all things social are not exactly black and white, this may also be referred to by the term “hidden expectations” rather than “hidden rules”, since so many students interpret “rules” in an always-the-same/never changes manner. Hidden expectations apply to all different types of situations and contexts. No matter where we find ourselves, when we are around other people there is a set of hidden expectations we all share. Students are asked to consider some “hidden rules/expectations” in the following situations: eating dinner at a nice restaurant, inviting a friend to a movie, calling someone on the phone, and riding the bus. Students are asked how they can use the Details lens and the Missing Information lens to determine what some ‘hidden rules/expectations’ are for different social situations.

The location 410 lens refers to the definitions of: location—a position or site occupied or available for occupancy or marked by some distinguishing feature; a tract of land designated for a purpose. Students are asked to consider where they are, or their location, as an important piece of social communication strategy. For example, we will use different communication strategies to ask for help at school than at home. People may also ask to take a break or use the restroom differently at work versus at church or a party. Paying attention to where you currently are, or where you are going, can help you identify Rules and Hidden Rules for the location before you even arrive. Students are asked to give an example of how they would ask for help, to use the restroom, or ask a question in the following locations: school, mall, home, theatre, gas station, and a restaurant. They students are asked what details they needed to know or observe in each location to know how to respond, and whether they can assume that how they respond in one location, for example a restaurant in Bozeman, would be the same in another city or state.

The language/vocabulary 411 lens refers to the definitions of language—the words, their pronunciation, and the methods of combining them used and understood by a community; a systematic means of communicating ideas or feelings by the use of conventionalized signs, sounds, gestures, or marks having understood meanings; and vocabulary—a sum or stock of words employed by a language, group, individual, or work or in a field of knowledge; a list or collection of terms or codes available for use. Students are asked to consider how we choose our words, and how knowledge of history, location, and details affects or changes the words we use when interacting with others. Students are asked to provide an example of their own personal vocabularies for different situations. (for example: bathroom and restroom are synonyms—at my friend's house, I would ask her where her bathroom is; at a business, I would ask where the restroom is). Students are asked to consider why they may use a different word in each location, what formal and informal language is, and to give examples. They are asked whether a person can have a formal vocabulary and an informal vocabulary for the same situation.

The over time 412 lens refers to the socio-cognitive concepts of: over-across time—the measured or measurable period during which an action, process, or condition exists or continues; a moment, hour, day, or year as indicated by a clock or calendar. The Over Time lens is much like the History lens in the sense that you are looking at past behavior or outcomes and applying them to communication choices in the present. However, The Over Time lens also applies to the future. You always have an opportunity to adjust your communication strategies Over Time including during a conversation or social interaction. You can even make a specific plan or goals for the future including how you will communicate, your Vocabulary/Language choices, how you will find out Missing Information, and taking into account Multiple Perspectives. Students are asked to give three examples of social communication situations that they would make a plan for, what their plan would look like for asking someone on a date, during a job interview, and ordering pizza. The students are asked to describe how someone's communication has changed with them Over Time.

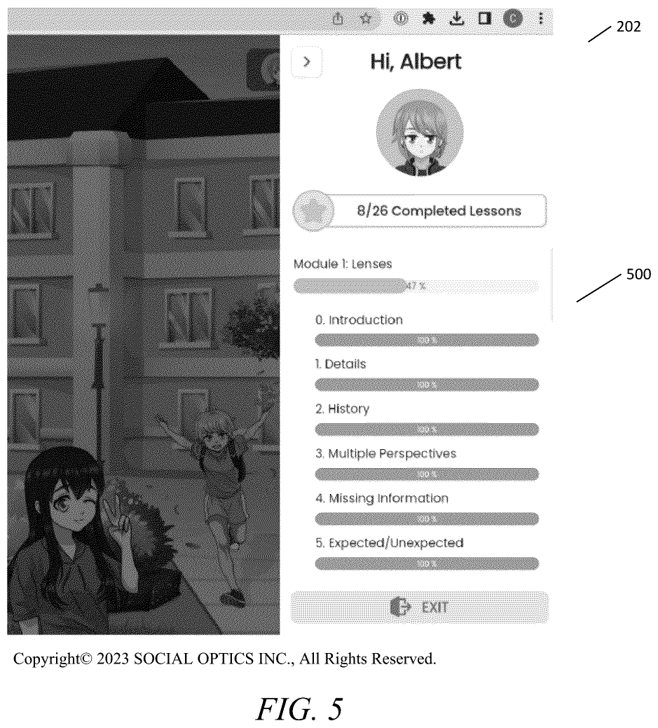

FIG. 5 is an example for the GUI 202 with a screen showing a student lesson page for the lenses 208 module of the cloud application 111 in accordance with an embodiment. A list or lessons 500 is a selectable list from which a student may select from the various lessons in the module. For this example, the student may select any of the lessons in the lenses 208 module as were described above. The GUI screen also shows progress the student has made including percentage completion of each lesson and a total number of lessons completed. The student may scroll the list of lessons 500 to further lessons, selected from a lesson displayed, etc.

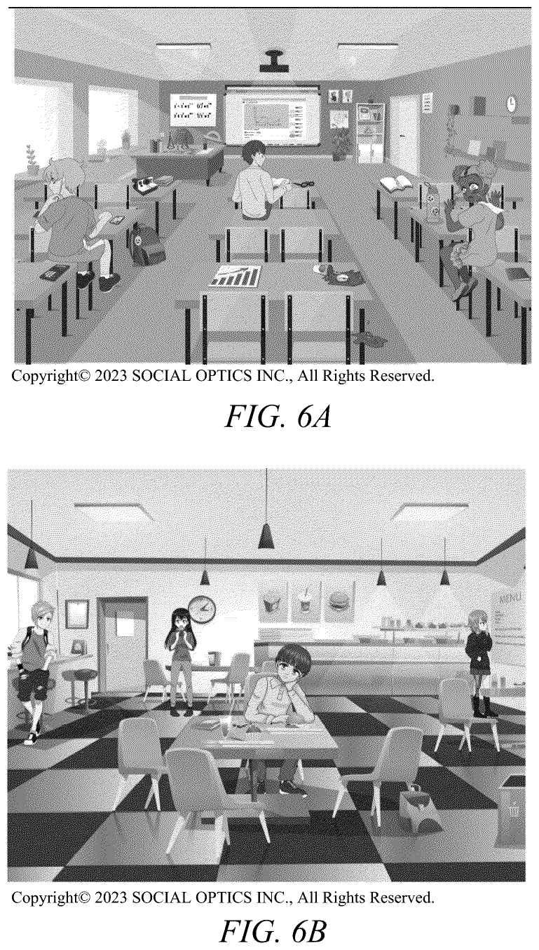

FIG. 6A and FIG. 6B are examples of social scenarios provided by the cloud application 111 where the social scenarios are provided using anime-influenced characters in a manga style format. FIG. 6A is a math class scenario, and FIG. 6B is a cafeteria scenario. Each of these scenarios as well as other scenarios may be presented to students for analysis and problem solving in any of the various lesson modules.

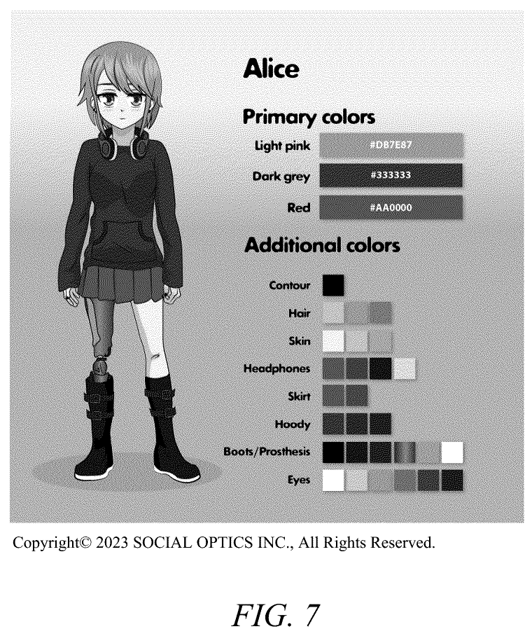

FIG. 7 is an example anime-style character showing their appearance and color scheme specifications for the cloud application 111 GUI 202 in accordance with an embodiment. FIG. 7 is a specification for a character named Alice.

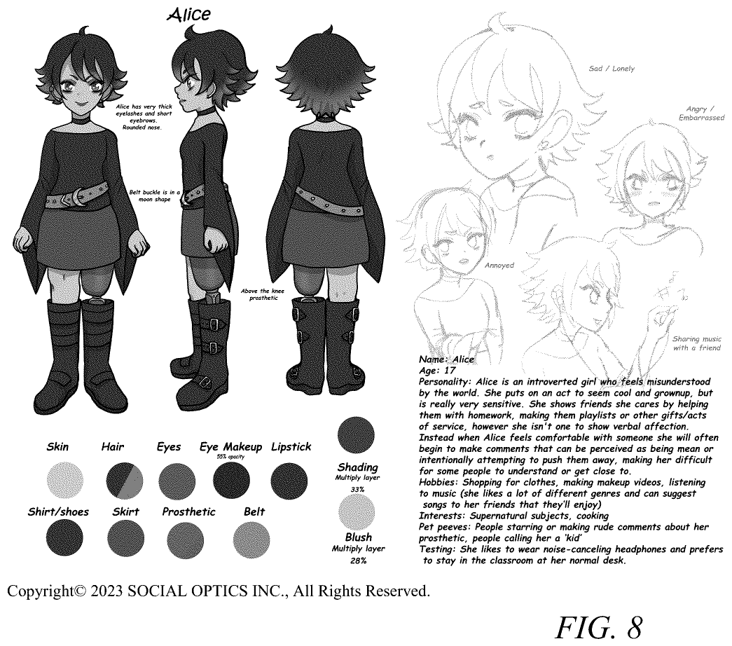

FIG. 8 is an example of a character design, showing their appearance, color scheme, and personality specifications for the cloud application 111 GUI 202 in accordance with an embodiment. For example, FIG. 8 is a specification for the character Alice, and shows facial expressions she may exhibit for various emotional states such as “sad/lonely,” “annoyed,” “angry/embarrassed,” and “sharing music with a friend.” The personality description includes hobbies, interests, pet peeves, and personal preferences such as, in this example, her preferences when testing.

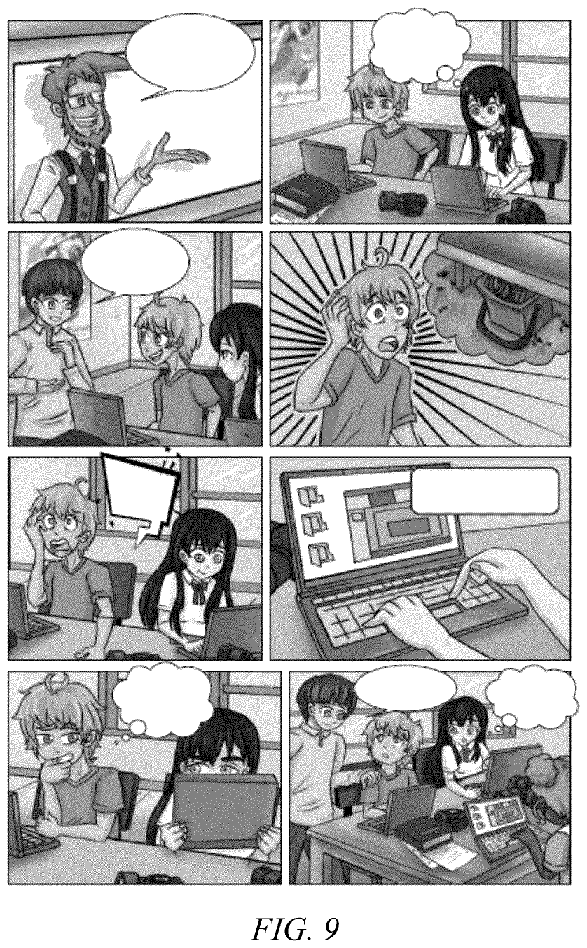

FIG. 9 is an example of a graphic novel generated by the cloud application 111 by the manga novel creation input module 207A using student inputs. As shown in the example of FIG. 9, the pages of the graphic novel include dialogue bubbles, thought bubbles and other narrative text portions that are populated with student input at the completion of each lesson. Once completed, the student may generate an NFT version using the NFT generation module 207B. The student may opt to share the novel with a teacher for further sharing as a new lesson with other students.

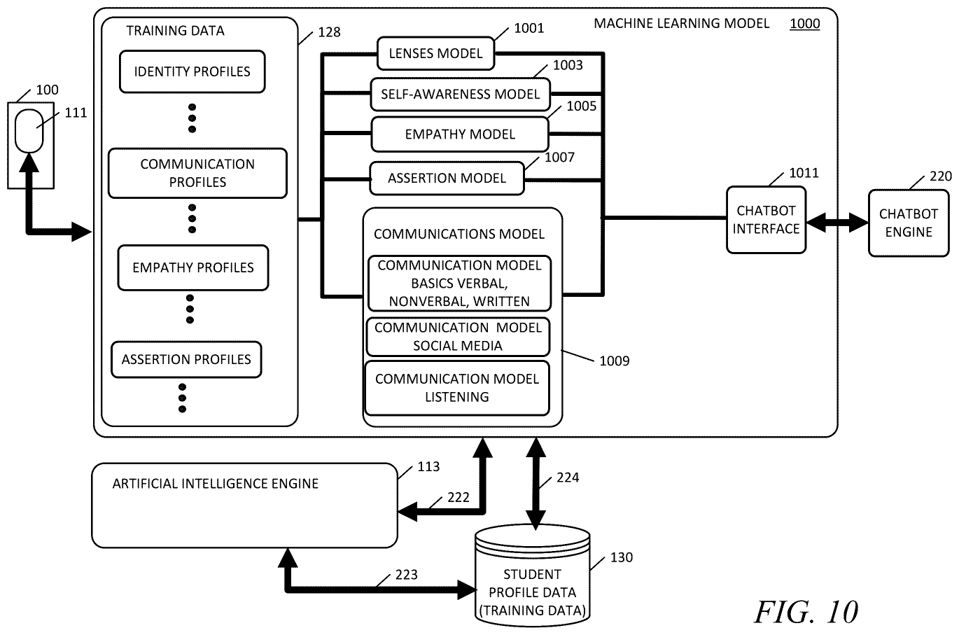

FIG. 10 is a block diagram of a machine learning model 1000 for a social interaction training apparatus in accordance with various embodiments. The cloud application 111 collects training data via the generated student profiles and anonymizes the profiles for use in building the machine learning model 1000. The machine learning model 1000 may be composed of various sub-models that can work together to form the overall machine learning model 1000. For example, the machine learning model 1000 may include a lenses model 1001, a self-awareness model 1003, an empathy model 1005, an assertion model 1007, and a communications model 1009. The communications model 1009 may also be composed of sub-models such as verbal, nonverbal and written communications, social media communications, and listening. Each of the machine learning models is operatively coupled to the cloud server 100 and the cloud application 111, to receiving training data 128 which may be composed of identity profiles, communication profiles, empathy profiles and assertion profiles that were generated via the cloud application 111. The AI engine 113 may access these models and update them accordingly using the training data.

In some embodiments, the AI engine 113 is an AI engine designed to interact with humans such as used by the cloud application 111. More particularly, the AI engine 113 may update lessons and provide customization of lessons including MCQs and open-ended questions presented to specific students in each lesson module based upon their needs and in response to updates to the specific related machine learning models of the machine learning model 1000 overall.

In other embodiments, the AI engine 113 may be a general-purpose AI engine that interacts with humans such as a robotic system that includes audio and visual sensing capability. The robotic system may be trained using the machine learning model 1000 such that it may react to human facial expressions and interact in a more human fashion. Such robotic systems using general LLM models may exhibit behavior and response similar to what may be observed in neurodivergent people in that the general AI systems have no context for human interaction. These contexts may be provided to the AI systems using the machine learning model 1000 herein disclosed. In one example, an AI engine may be a customer service AI system that interact with customers calling in on a telephone system and can detect tonal changes in a human caller's voice for example. The tonal changes may be used to change the interaction procedure of the AI engine based on the machine learning model 1000. Other various applications of the machine learning model 1000 may be envisioned based on the present disclosed embodiments. The machine learning model 1000 may also have a chatbot interface 1011 to facilitate text or text to speech, or speech to text communication.

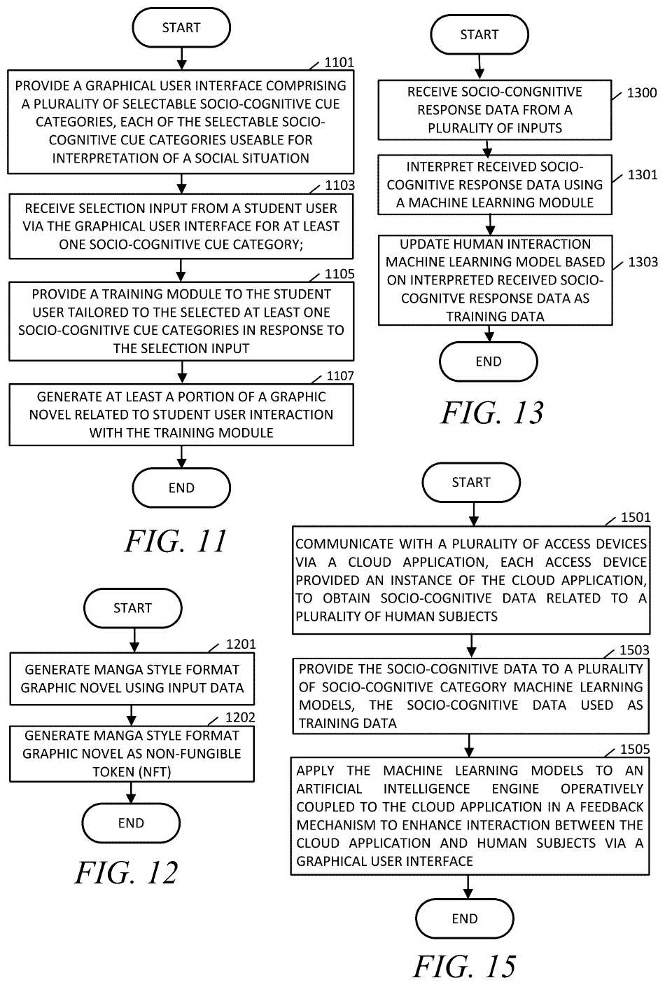

FIG. 11 is a flow chart showing operation of a cloud server processor in accordance with various embodiments. At operation 1101, a cloud server processor provides a graphical user interface with a plurality of selectable socio-cognitive cue categories, where each of the selectable socio-cognitive cue categories is correlated to interpretation of a social situation. The socio-cognitive cue categories are referred to herein as “lenses.” At operation 1103 the processor receives selection input from a student user via the graphical user interface 202 for at least one socio-cognitive cue category (i.e. for a lens). In operation 1105, the GUI 202 (via the processor and cloud application 111) provides a training module to the student user tailored to the selected at least one socio-cognitive cue categories in response to the selection input. At operation 1107, the processor generates at least a portion of a graphic novel related to student user interaction with the training module. In the flow chart of FIG. 12, at operation 1201 the processor may generate the portion of the graphic novel in a manga style format and at operation 1202 may generate an NFT for the novel.

FIG. 13 is a flow chart of a method of operation of an AI engine in conjunction with the cloud computer system. At operation 1300, the cloud computer system receives socio-cognitive response data form a plurality of inputs. At operation 1301, an AI engine interprets the socio-cognitive response data using a machine learning model. At operation 1303, a human interaction machine learning model is updated based on the received socio-cognitive response data as training data.

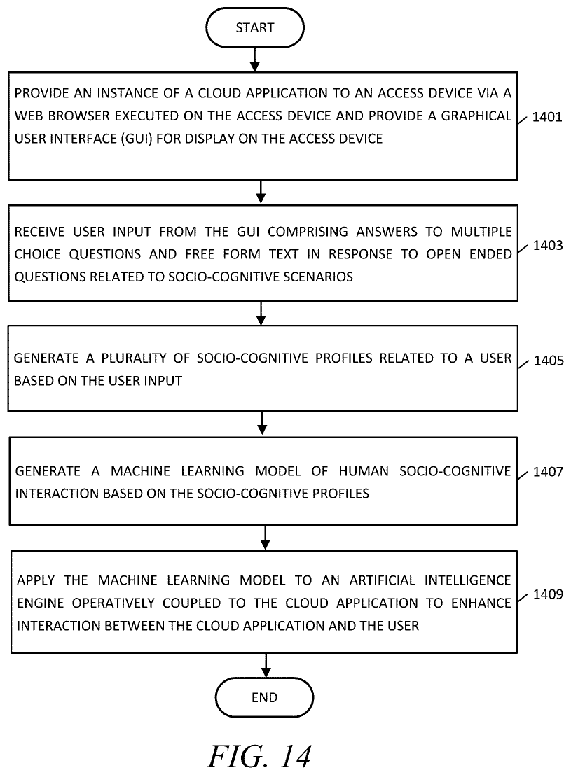

FIG. 14 is a flow chart showing operation of a cloud server computer system in accordance with an embodiment. At operation 1401, the cloud server computer system provides an instance of a cloud application to an access device via a web browser executed on the access device and provides a GUI for display on the access device. At operation 1403, the cloud server computer system receives user input from the GUI comprising answers to multiple choice questions and free form text in response to open ended questions related to socio-cognitive scenarios. At operation 1405, the cloud server computer system generates a plurality of socio-cognitive profiles related to a user based on the user input. At operation 1407, the cloud server computer system generates a machine learning model of human socio-cognitive interaction based on the socio-cognitive profiles. At operation 1409, the cloud server computer system applies the machine learning model to an artificial intelligence engine operatively coupled to the cloud application to enhance interaction between the cloud application and the user. The AI engine may then generate MCQs as well as open ended questions tailored to a specific user based on the updated models. Models may be built around a specific user as well as general models that apply to all users. Temporary user specific models may be used to generate user specific content. User data may also be anonymized and applied as global training data to overall global machine learning models that provide a feedback mechanism to the cloud application 111 such that the cloud application 111 learns from each user how best to provide lesson content based on that specific student's needs as detected by the AI engine using the various human interaction models.

FIG. 15 is a flowchart of another method of operation of a cloud server computer system in accordance with some embodiments. In operation 1501, the cloud server computer system communicates with a plurality of access devices via a cloud application, where each access device is provided an instance of the cloud application, to obtain socio-cognitive data related to a plurality of human subjects. In operation 1503, the cloud server computer system provides the socio-cognitive data to a plurality of socio-cognitive category machine learning models, such that the socio-cognitive data is used as training data. In operation 1505, the cloud server computer system applies the machine learning models to an artificial intelligence engine operatively coupled to the cloud application in a feedback mechanism to enhance interaction between the cloud application and human subjects via a graphical user interface.

The cloud server computer system may provide the machine learning models to an artificial intelligence engine operatively coupled to a robotic system. The cloud server computer system may obtain the socio-cognitive data related to a plurality of human subjects by providing a series of multiple-choice questions and open-ended questions to the human subject via a user interface of the cloud application. The cloud server computer system may obtain the socio-cognitive data related to a plurality of human subjects by providing a series of questions corresponding to a social narrative provided to the human subjects. The social narratives are provided to the human subjects in a manga style format and using anime-influenced characters.

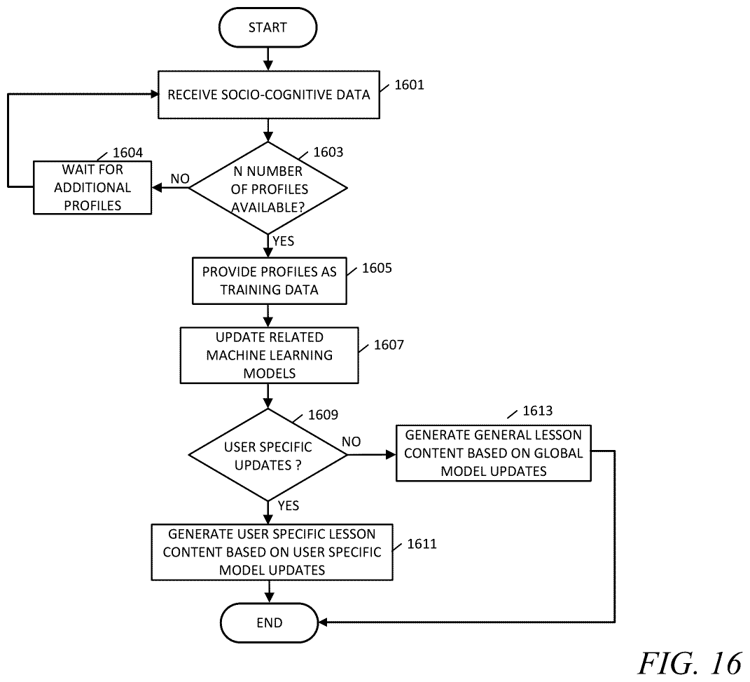

FIG. 16 is a flow chart showing operation of a cloud computer system generating machine learning training data in accordance with an embodiment. The method of operation begins and in operation 1601 the cloud server receives socio-cognitive data. If a given number of profiles are created at decision block 1603, the profiles are provided as training data in operation 1605. Otherwise, the system waits for additional profiles in operation 1604. For example, the system may wait until the identity profile, communication profile, empathy profile, and assertion profile are completed if the modeling is for a specific human subject. In other embodiments, in which a global model is being obtained, the system may wait for a specific number (“N”) of a specific profile before compiling the data and using it as training data. For example, the system may wait for one-hundred profiles or any other suitable number of profiles before sending the data. The number of profiles may be set via a setting within the cloud application 111.

If training data is provided, then in operation 1607, the related machine learning models are updated. For example, in some embodiments, the machine learning models include LLM engines, and a user specific prompt may be updated based on the training data (the data contained in the profiles). If at decision block 1609 the updates are user specific as discussed above, then at operation 1611 user specific lesson content may be generated based on the user specific model updates (e.g., customized text is generated for the user based on including data from the profiles in the prompt to the LLM for generating the customized text) and the method of operation terminates for the current update cycle. If the updates are global updates at decision block 1609, then at operation 1613 general lesson content may be generated or updated based on the global model updates.

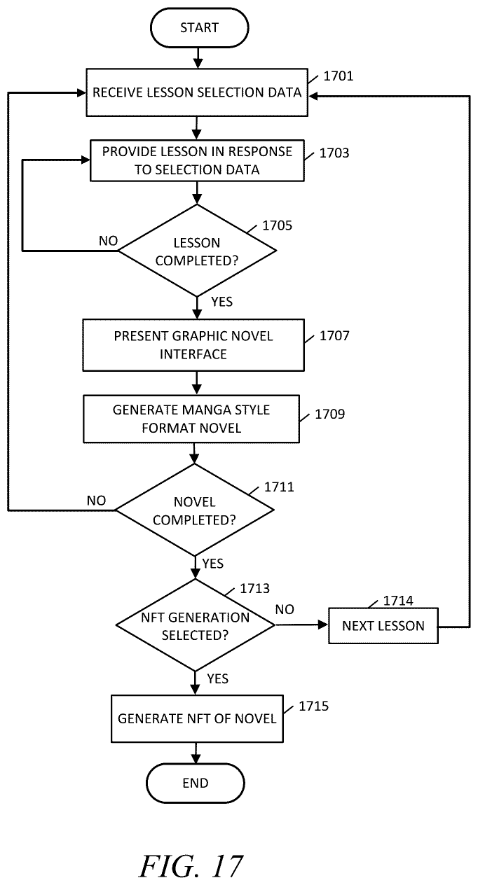

FIG. 17 is a flow chart showing operation of a cloud computer system in accordance with an embodiment. At operation 1701, the cloud computer system receives lesson selection data from user input provided to the GUI 202. At operation 1703 the cloud application 111 provides a lesson in response to the selection data. If the lesson is completed at decision 1705, the graphic novel interface is presented in operation 1707. If not, the instance of the cloud application 111 waits for further selection data in operation 1703. In operation 1709, the graphic novel is generated in a manga style format. If the novel is completed at decision 1711, the user may select to generate an NFT of the novel at decision 1713 and an NFT is generated at 1715. If no NFT is generated, the system may proceed to the next lesson at operation 1714 and wait for further selection data at operation 1701. Likewise, if the novel is not completed at decision 1711 the system will wait for further selection data at operation 1701.

As disclosed in detail above, in operation of the cloud application 111, a human subject is presented with set of social settings and scenarios that involve a social interaction narrative requiring the student to application socio-cognitive cue categories (referred to herein as “lenses”) to analyze and understand contextually the proper responses, emotions or behaviors that would be appropriated for the given social interaction narrative. Scenarios are presented using characters in an anime format with anime-influenced character appearance and anime-influenced animation in some embodiments. Machine learning models are generated and updated accordingly based on received input data. The machine learning models may be large language models (LLMs) in some embodiments.

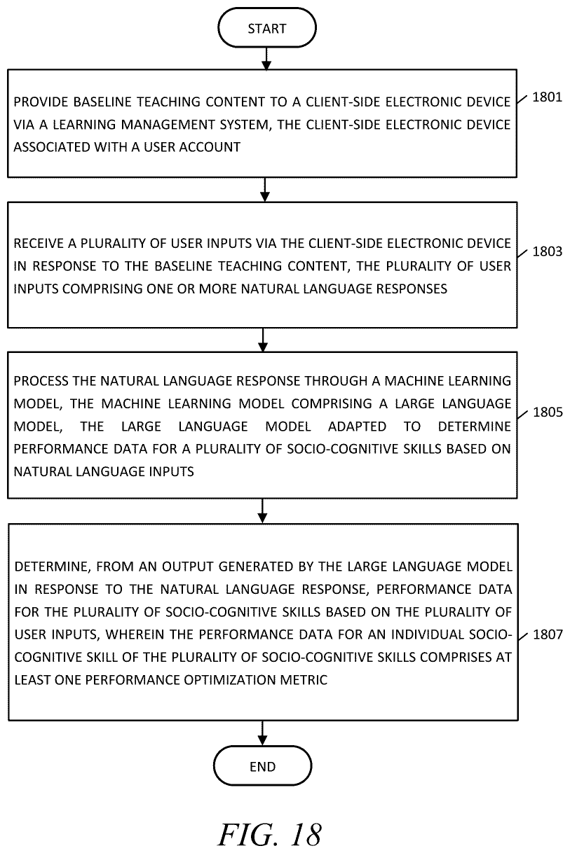

FIG. 18 is a flowchart depicting a method for determining student progress across a multivariate set of learning goals using a learning management system, in accordance with an embodiment of the present disclosure. In some embodiments, the learning management system provides 1801 baseline teaching content to a client-side electronic device. Typically, the client-side device is signed into a user account on the learning management system. The baseline teaching content may include a variety of different content types that aid in teaching, training, or assessing one or more skills or topics. For example, the baseline content may include lessons and exercises, interactive modules, questions, scenarios, graphics, videos, games, text, audio, and more. In some embodiments, the same baseline teaching content may be provided to a group of users. The group of users may be defined in different ways, such as grade (school class year), geographic location, spoken language, or affiliation (such as school or organization). In some embodiments, the group of users includes all users of the learning management system.

As users engage with the teaching content, a plurality of user inputs are received 1803 by the learning management system via the client-side electronic device. In some embodiments, the user inputs may include natural language responses. Examples of natural language response may be answers to open-ended questions or prompts, journal entries, chat content, essays, written dialogue and thoughts of characters in a graphic novel (e.g., by filling the blanks of a graphic novel, an example page of which is shown in FIG. 9), and the like. The natural language responses are processed 1805 through a machine learning model. In some embodiments, the machine learning model includes a large language model that is adapted to determine performance data for one or more socio-cognitive skills based on the natural language inputs. In other words, the natural language response serves as an input to the large language model, and the large language model provides an output that includes performance data for each of the socio-cognitive skills. In some embodiments, the large language model may be adapted for the specific use case of determining performance for the socio-cognitive skills by prompting the large language model to evaluate natural language responses for each of the socio-cognitive skills. In some embodiments, the natural language model may be further prompted with definitions and/or labeled example inputs for each socio-cognitive skill.

The socio-cognitive skills associated with the learning management systems may be predefined for the specific system or use case. For example, and as illustrated in FIG. 4, the socio-cognitive skills categories may include details 401, history 402, multiple perspectives 403, missing information 404, expected/unexpected behaviors 405, ethics/morals 406, patterns 407, main point 408, rules/hidden rules 409, location 410, language/vocabulary 411, and over time 412.

The learning management system then determines 1807, from an output generated by the large language model in response to the natural language response, the performance data for the plurality of socio-cognitive skills based on the plurality of user inputs The performance data for an individual socio-cognitive skill may include computer-facing information such as a score between 0 and 1 for how strongly the natural language response is associated with or demonstrates each of the socio-cognitive skills. The performance data may also include human-facing information such as a letter grade, recommendations, and the like. In some embodiments, the performance data may include an optimization metric that is further used by the machine learning model or related content generation model. In some embodiments, the large language model is fine-tuned (or re-trained) based on training data, where the training data may include collected samples of natural language responses and samples of performance data regarding those responses, as determined by a human evaluator (e.g., a psychologist).

In some embodiments, the learning management model generates personalized teaching content for the user account based on the performance data of the one or more socio-cognitive skills. For example, if the performance data indicates that the user is not performing well on a certain skill, the personalized teaching content may incorporate more content associated with that particular skill, such as by generating additional questions relating to developing that skill or by leading a student through an analysis by using that skill. For example, the personalized teaching content may be presented to the user via the chatbot interface 217, where the chatbot engine 220 is configured or steered (e.g., by including instructions in a prompt of an LLM) to engage in a chat conversation with the user regarding the particular skill, such as by leading the user through a social scenario involving the particular skill. The personalized teaching content may be selected or generated by the machine learning model by optimizing for the optimization metric associated with the particular skill. The personalized teaching content may then be provided to the client-side electronic device via the learning management system.

In some embodiments, the learning management system generates one or more profiles associated with the user account. The profiles, such as the communication profile 212, empathy profile 214, and assertion profile 216 illustrated in FIG. 2, may be based at least in part on the performance data generated by the large language model for the plurality of socio-cognitive skills. The profiles may give a snapshot of the user's progress or degree of mastery in a particular area, and/or particular areas that require more attention or improvement.

In some embodiments, the machine learning model may also determine whether the user inputs may be indicative of certain special learning conditions, such as learning difficulties, attention issues, visual vs auditory learning effectiveness, and the like. For example, the machine learning model may detect a pattern in the user inputs that indicates the user learns more effectively when information is presented aurally rather than visually. In another example, the machine learning model may detect a pattern in the user inputs that indicates the user performs well for first 20 minutes, and then falls off after that amount of time. These patterns may be used to personalize the content served to the user as well as to inform educators about the user's tendencies. In addition to user's answers to questions and prompts, the user input may also include many types of interaction data, such as mouse movement, speed of actions, graphical display settings, pause time, volume, and the like.

In addition to using machine learning to personalize teaching content for individual users, the learning management system may also update the baseline teaching content over time by identifying patterns in the performance data for the plurality of socio-cognitive skills across a plurality of user accounts. For example, if the average performance metric for a certain skill is low across all users or a certain group of users, the baseline teaching content may be adjusted to improve the average performance for that particular skill.

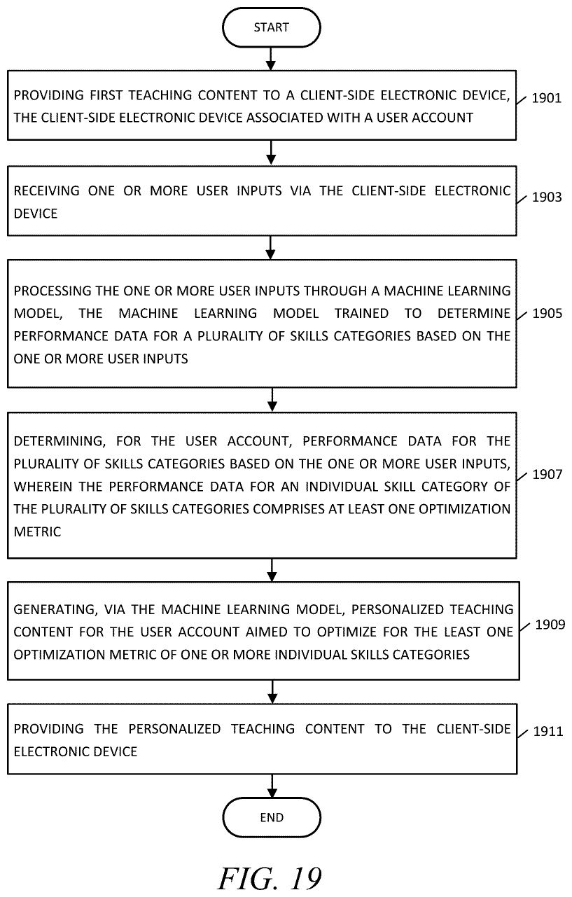

FIG. 19 is a flowchart depicting a method for personalizing teaching content across a multivariate set of learning goals a using a learning management system, in accordance with an embodiment of the present disclosure. In some embodiments, the learning management system provides 1901 first teaching content to a client-side electronic device associated with a user account. The first teaching content may include various forms of content, such as lessons and exercises, interactive modules, questions, scenarios, graphics, videos, games, text, audio, and more. The first teaching content may be a baseline set of teach content that is served to all or a certain group of users, or the first teaching content may be content that has been personalized for the specific user. As the user interacts with the learning management system on the via the client-side electronic device, the learning management system receives 1903 one or more user inputs via the client-side electronic device. The user inputs may include various different types of inputs, such as the user's answers to questions or prompts presented in the teaching content. In some embodiments, the user inputs may include natural language responses, such as words, phrases, and sentences. Accordingly, the machine learning model includes a natural language model trained to determine at least a portion of the performance data for the plurality of skills categories based on natural language responses. For example, the machine learning model may score the one or more natural language inputs with respect to the plurality of skills categories. In some embodiments, the teaching content may prompt the user to provide descriptions, dialogue, or thought narratives in the context of a graphic novel, as illustrated in FIG. 9. The natural language responses may also be journal entries, essays, and the like.

The user inputs may also include settings the user has selected, such as brightness, volume, display colors, text size, audio/video speed, and the like. The user inputs may also include human-computer interaction data, such as mouse movements, typing speed, typing errors and corrections, periods of inactivity, delays in response time, and the like.

At least a portion of the user inputs are processed 1905 through a machine learning that has been trained to determine performance data for a plurality of skills categories based on the user inputs. Specifically, in some embodiments, the performance data for an individual skill category includes at least one optimization metric. In some embodiments, the machine learning model may be trained on training data that includes various teaching content, user inputs, user profile data, and optimization metrics associated with the plurality of skills categories. Thus, the learning management system is able to determine 1907, for the user account, performance data for the plurality of skills categories based on the user inputs.

In some embodiments, learning management system utilizes the machine learning model or a related content generation model to generate 1909 personalized teaching content for the user account aimed to optimize for the optimization metric of one or more skills categories. The personalized teaching content is then provided 1911 to the client-side electronic device. In some embodiments, the personalized teaching content is new content that is dynamically generated by a generative machine learning model. In some embodiments, the personalized teaching content is selected from a corpus of available teaching content.

In some embodiments, the machine learning model may identify one or more patterns in the performance data for the plurality of skills categories across a plurality of user accounts and update the teaching content based on these identified patterns. This allows the learning management system to iteratively and automatically improve the teaching content provided to all users as it is used and as more data is collected.

The machine learning techniques employed in the present disclosure make it possible to determine patterns and insights that would otherwise remain hidden. Optimizing for the way students learn is an age-old problem. This is in part due to the fact that every student is different, with different natural born abilities, experiences, environments, and more. This is particularly the case in neurodivergent individuals, for which there are even more variables, unknowns, and potential hurdles. Employing machine learning technology, which has the advantage of collecting and processing huge amount of multivariate data for each student, has the potential to not only reveal hidden patterns and insights, but in real-time generate, test, and refine new teaching content and techniques to optimize individual as well as group performance. The systems and techniques of the present disclosures employ machine learning techniques to perform multivariate analysis of student learning performance and personalized content generation, both of which represent significant technological advancement in the field of education.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A computer system comprising:
non-volatile, non-transitory memory; and
at least one processing circuit, operatively coupled to the non-volatile, non-transitory memory, the at least one processing circuit operative to:
provide baseline teaching content to a client-side electronic device via a learning management system, the client-side electronic device associated with a user account;
receive a plurality of user inputs via the client-side electronic device in response to the baseline teaching content, the plurality of user inputs comprising one or more natural language responses;
process the natural language response through a machine learning model, the machine learning model comprising a large language model, the large language model adapted to determine performance data for a plurality of socio-cognitive skills based on natural language inputs; and
determine, from an output generated by the large language model in response to the natural language response, performance data for the plurality of socio-cognitive skills based on the plurality of user inputs, wherein the performance data for an individual socio-cognitive skill of the plurality of socio-cognitive skills comprises at least one performance metric.

2. The computer system of claim 1, wherein the at least one processing circuit is further operative to:
generate personalized teaching content for the user account aimed to optimize for the least one performance metric of one or more individual socio-cognitive skills; and
provide the personalized teaching content to the client-side electronic device via the learning management system.

3. The computer system of claim 1, wherein the at least one processing circuit is further operative to:
generate a user profile associated with the user account, the user profile comprising information based at least in part on the performance data generated by the large language model for the plurality of socio-cognitive skills.

4. The computer system of claim 1, wherein the at least one processing circuit is further operative to:
train the machine learning model on training data comprising teaching content, user inputs, user profile data, and performance metrics of the plurality of socio-cognitive skills.

5. The apparatus of claim 1, wherein the at least one processing circuit is further operative to:
determine, based on one or more of the plurality of user inputs, one or more learning difficulties, special needs, or learning styles associated with the user account.

6. The computer system of claim 1, wherein the at least one processing circuit is further operative to:
identify patterns in the performance data for the plurality of socio-cognitive skills across a plurality of user accounts; and
update the baseline teaching content based at least in part on the identified patterns.

7. A computer-implemented method, comprising:
providing first teaching content to a client-side electronic device, the client-side electronic device associated with a user account;
receiving one or more user inputs via the client-side electronic device;
processing the one or more user inputs through a machine learning model, the machine learning model trained to determine performance data for a plurality of skills categories based on the one or more user inputs;
determining, for the user account, performance data for the plurality of skills categories based on the one or more user inputs, wherein the performance data for an individual skill category of the plurality of skills categories comprises at least one optimization metric;
generating, via the machine learning model, personalized teaching content for the user account aimed to optimize for the least one optimization metric of one or more individual skills categories; and
providing the personalized teaching content to the client-side electronic device.

8. The computer-implemented method of claim 7, wherein the one or more user inputs comprises one or more natural language responses.

9. The computer-implemented method of claim 8, wherein the machine learning model comprises a natural language model trained to determine at least a portion of the performance data for the plurality of skills categories based on the one or more natural language responses.

10. The computer-implemented method of claim 9, further comprising:
scoring, by the machine learning model, the one or more natural language inputs with respect to the plurality of skills categories.

11. The computer-implemented method of claim 8, wherein the one or more natural language responses comprise natural language responses supplied to the client-side electronic device as text of a graphic novel.

12. The computer-implemented method of claim 7, wherein the personalized teaching content comprises new content dynamically generated by a generative machine learning model.

13. The computer-implemented method of claim 7, wherein the personalized teaching content is selected from a corpus of available teaching content.

14. The computer-implemented method of claim 7, further comprising:
identifying, via the machine learning model, one or more patterns in the performance data for the plurality of skills categories across a plurality of user accounts; and
updating the first teaching content based at least in part on the one or more identified patterns.

15. The computer-implemented method of claim 7, wherein the first teaching content comprises one or more of: multiple choice questions, open-ended prompts, text, graphics, and audio.

16. A non-transitory computer-readable medium storing instructions that, when executed by a processor, cause the processor to:
provide first teaching content to a client-side electronic device, the client-side electronic device associated with a user account;
receive one or more user inputs via the client-side electronic device;
process the one or more user inputs through a machine learning model, the machine learning model trained to determine performance data for a plurality of skills categories based on the one or more user inputs;
determine, for the user account, performance data for the plurality of skills categories based on the one or more user inputs, wherein the performance data for an individual skill category of the plurality of skills categories comprises at least one optimization metric;
generate, via the machine learning model, personalized teaching content for the user account aimed to optimize for the least one optimization metric of one or more individual skills categories; and
provide the personalized teaching content to the client-side electronic device.

17. The non-transitory computer-readable medium of claim 16, wherein the one or more user inputs comprises one or more natural language responses and the machine learning model comprises a natural language model trained to determine at least a portion of the performance data for the plurality of skills categories based on the one or more natural language responses.

18. The non-transitory computer-readable medium of claim 16, wherein the personalized teaching content comprises new content dynamically generated by a generative machine learning model.

19. The non-transitory computer-readable medium of claim 16, wherein the personalized teaching content is selected from a corpus of available teaching content.

20. The non-transitory computer-readable medium of claim 16, further storing instructions that, when executed by the processor, cause the processor to
identify, via the machine learning model, one or more patterns in the performance data for the plurality of skills categories across a plurality of user accounts; and
update the first teaching content based at least in part on the one or more identified patterns.
